(19) United States
(12) Patent Application Publication
(10) Pub. No.: US 2017/0114814 A1
(43) Pub. Date: Apr. 27, 2017

(54) Thin-Sheet Clinch Fastener

(71) Applicant: Penn Engineering & Manufacturing Corp., Danboro, PA (US)

(72) Inventor: Michael J. Maloney, Doylestown, PA (US)

(21) Appl. No.: 15/298,815

(22) Filed: Oct. 20, 2016

Related U.S. Application Data
(60) Provisional application No. 62/245,079, filed on Oct. 22, 2015.

(51) Int. Cl. F16B 19/06; F16B 37/06

(52) U.S. Cl. CPC F16B 19/06; F16B 37/065

(57) ABSTRACT

A unitary metal clinch fastener comprises a top most head and an inwardly tapered shoulder extending axially downwardly from and located immediately below the head. The shoulder has an outwardly-facing angled surface for deforming material of a metal panel into which the fastener is installed. An outwardly-flared shank is located below the shoulder. The shank has an upwardly-facing outer surface adapted to engage an edge of an installation hole in the panel. A neck of reduced diameter is located at a junction of the shank and the shoulder and is adapted to engage the edge of the installation hole to attach the fastener to the panel. The panel installation hole is centered in a conical recessed section of the panel and is convergently-angled downwardly with the edge of the hole abutting the upwardly-facing surface of the shank.

### RELATED APPLICATIONS

This is a non-provisional patent application of U.S. provisional patent application No. 62/245,079 entitled “Thin Sheet Clinching Fastener” filed on Oct. 22, 2015, priority from which is hereby claimed.

### FIELD OF THE INVENTION

The present invention relates to clinch fasteners that are especially useful for installation and use on thin-sheet metal panels.

### BACKGROUND OF THE INVENTION

Clinch fasteners are well known for permanently affixing a hardened fastener to a sheet metal panel. Clinch fasteners typically include a head 13, a displacer 14, an undercut 15 and a shank 19 arranged sequentially from the head end to the distal free end of the fastener such as shown in FIG. 1. When inserted and pressed into an aperture in a sheet metal panel 17, the displacer deforms and pushes metal surrounding the aperture into the undercut such as shown in FIG. 2. The undercut is formed between the displacer and the shank, and has a diameter less than the diameter of the shank. Depending on its length, the shank may or may not extend past the bottom of the panel. When the length of the shank is selected to be flush with the bottom side of the sheet metal after installation, the shank, displacer and undercut are effectively contained within the thickness of the panel. When torque resistance is necessary, a non-round displacer is employed, which resists rotation once it is pressed into the panel.

Once a clinch fastener is permanently installed in the panel, the push-out strength of the fastener is governed by the thickness of the metal in the undercut, which is sheared off or pushed out when a force failure is induced. As the thickness of the metal in the undercut is reduced, the connection force between the fastener and the panel is also reduced.

Once the panel becomes very thin, for example in the range of 0.008″ thick, manufacturing methods begin to fail since the features necessary for clinching require a range of tolerance that is very difficult (if at possible at all) impossible to meet and still be functional. If a displacer and an undercut are required to be contained within a 0.008″ thick sheet, those features could only be 0.003 to 0.004″ thick, which generally precludes a construction wherein the fastener shank is flush on the bottom (anvil) side. Therefore, it would be desirable to provide a clinch fastener that can be installed in very thin panels. It would also be desirable to provide a clinch fastener that has increased push-out strength when installed in very thin panels.

### SUMMARY OF THE INVENTION

In one preferred embodiment, a unitary, thin-sheet clinch fastener fastener generally comprises: a top most head, an inwardly tapered shoulder, an outwardly-flared shank, and a neck of reduced diameter. The head has the largest diameter of any of the fastener components and may be circular with a cylindrical outer surface. The inwardly-tapered shoulder extends axially-downwardly from a base of the head. The shoulder has an outwardly-facing, downwardly-convergent, angled surface for deforming material of a metal panel into which the fastener is installed. The outwardly-flared shank is located immediately below the shoulder. The shank has an upwardly-facing outer surface adapted to engage an edge of an installation hole in the panel deformed by the shoulder. The shank has an undercut or neck of reduced diameter located at the junction of the shank and the shoulder. The neck is adapted to accept the edge of the installation hole such that the fastener is rigidly attached to the panel thereby. In one embodiment, the outer surface of the shoulder consists entirely of an outwardly-facing angled surface. A second undercut located below the shank provides attachment means for attaching a second object. The attachment means may have a convergently-tapered bottom portion extending downward to a bottom of the fastener.

The inventive fastener can be used in an assembly with a metal panel to which it is rigidly attached. The fastener extends through an installation hole which is centered in a conical-recessed section of the panel. The recessed portion of the panel around the installation hole abuts the fastener shoulder and is angled downwardly with the edge of the hole engaging the upwardly facing surface of the shank.

During the assembly process, material from the panel is deformed simply by pressing the fastener into the panel while the panel is supported on an anvil, which has a recess that compliments the size and shape of the shoulder. During pressing, the diameter of the installation hole is decreased, which causes the coined portion to close in around the fastener neck and close the installation hole. After pressing, the top of the fastener head can lie within the panel recess flush with the top surface of the panel.

The geometry of the assembly provides pull-out resistance that is much greater than a standard clinch fastener assembly. Pull-out forces, i.e., forces applied to the fastener in the direction opposite the direction of fastener installation, are counteracted by the in-line compressive resistance force of the panel. Because of this structural configuration, the invention provides a clinch fastener that can be used with very thin sheet metal, for example, in the range of 0.008 inches thickness.

The thin-sheet clinch fastener provides the following improved features compared to the prior art. Applicant's fasteners can be installed in metal sheets that are much thinner than the metal sheets in which standard clinch fasteners are typically installed. Applicant's fasteners can be created on very small scales, which are very difficult or impossible for standard size clinch fasteners. Installation of applicant's fasteners creates a cone-shaped recess in the metal panel, which surrounds the fastener and creates a new mode of retention. The reverse configuration of the cone creates compressive retaining forces, which are stronger than shear retaining forces created by the undercut of prior art clinching fasteners.

### BRIEF DESCRIPTION OF THE DRAWINGS

FIGS. 1 and 2 are cross sections of a prior art clinch fastener being installed and clinched to a sheet metal panel;

FIG. 3 is a cross section of a clinch fastener in accordance with a preferred embodiment of the invention, shown installed in a thin sheet metal panel prior to clinching;

FIG. 4 is a cross section of the clinch fastener of FIG. 3, shown after clinching to the thin sheet metal panel;

FIG. 5 is a cross section of the clinch fastener of FIG. 4 illustrating a push-out force;

FIGS. 6a, 6b, 6c and 6f are front elevations of clinch fasteners in accordance with additional embodiments of the invention; and,

FIGS. 6d and 6e are front elevations in partial cross section of clinch fasteners in accordance with further embodiments of the invention.

### DETAILED DESCRIPTION OF THE PREFERRED EMBODIMENTS

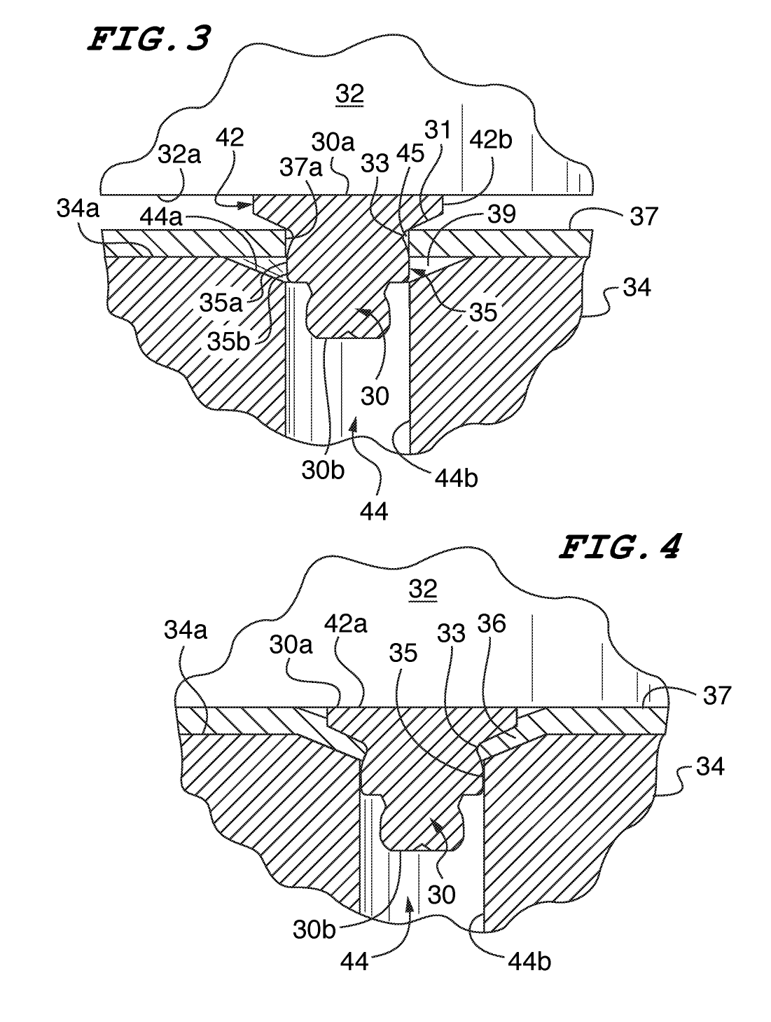

A clinch fastener in accordance with a preferred embodiment of the invention is shown in FIGS. 3-5 and is designated by reference numeral 30. The clinch fastener 30 has a circular cross-section and generally comprises a head 42, a displacer 31, an undercut 33, and a shank 35 arranged sequentially from the head end 30a to the distal free end 30b of the fasteners. While these structures have the same names as the structures of prior art clinch fasteners, applicant's fastener captivates differently and fails differently than prior art clinch fasteners.

The head 42 has a circular, planar top surface 42a and an annular rim 42b. The top surface is orthogonal to a central, longitudinal axis. In the preferred embodiment shown in FIGS. 3-5, the bottom surface of the head is skew to the central axis and forms a tapered shoulder 31. The shoulder 31 tapers inwardly extending from the head end 30 the distal free end 30b. In a preferred embodiment, the taper of the shoulder is linear and the shoulder has a frusto-conical shape. However, in other embodiments, the taper may be non-linear.

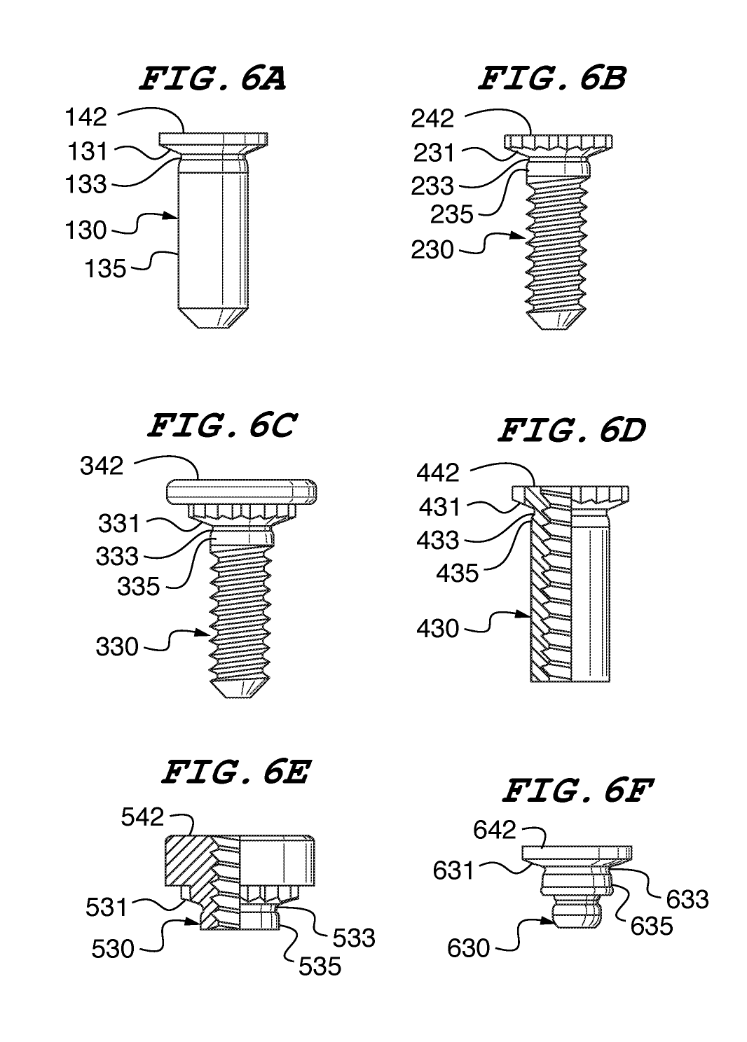

The distal end (relative to the head) of the shoulder 31 terminates at an undercut 33, which comprises a reduced-diameter portion or neck of the shank 35. As described below, the undercut 33 receives the cold flow of metal from the panel 37 during installation, which captivates the fastener 30 to the panel 37. In the embodiment shown in FIGS. 3-5, the undercut 31 has a convex, curved profile; however, in other preferred embodiments such as shown in FIGS. 6a-f, the undercut may have a straight profile.

The distal end (relative to the head) of the undercut 33 transitions smoothly to an outwardly-flared shank 35. The shank 35 has an upwardly-facing outer surface, which is adapted to engage the edge 37a of the panel 37 proximate the installation hole 45 when the panel 37 is deformed by the shoulder 31. The shank 35 diameter expands to a maximum diameter at an intermediate point 35a on the shank 35. The maximum diameter closely approximates the diameter of the installation hole 45 in the panel 37. The distal portion of the shank 35b past the intermediate point may have a variety of constructions and profiles such as shown in the preferred embodiment, or the alternative embodiments shown in FIGS. 6a-f.

A method of installing the fastener 37 in accordance with a preferred embodiment of the invention is also illustrated in FIGS. 3 and 4. In this embodiment, the method includes novel tooling especially useful for clinching to thin sheet metal panels. The installation tooling includes a press tool 32 having a flat head 32a, and an anvil 34 having a central bore 44 extending from the top surface 34a to a depth preferably at least as great as the length of the fastener 30. The upper portion of the bore 44a has a frusto-conical size and shape that compliments the size and shape of the fastener shoulder 31, which forms a conical recess 39. The lower portion of the bore 44b is generally cylindrical.

Referring to FIG. 3, the fastener 30 is initially installed in the installation hole 45 of the thin-sheet metal panel 37, which is supported on the anvil 34. The metal panel 37 must be properly aligned so that the installation hole 45 is concentric with the central bore 44 of the anvil. At this initial stage, the fastener is supported in the installation hole 45 by contact points between the shoulder 31 and the edge of the panel 37, among possible other contact points depending on the relative sizes of the panel 37 and fastener 30.

Referring to FIG. 4, the press tool 32 then forces the fastener downwardly until the top surface 30a of the fastener 30 is flush with the top surface of the panel 37. During this downward movement, the fastener 30 deforms and clinches to the panel 37. During clinching, the portion of the panel surrounding the installation hole 45 is deformed into a frusto-conical shape. The portion of the panel surrounding the installation hole that is deformed during clinching is referred to as the “coined portion 36.” Deformation of the coined portion 36 occurs because the shoulder 31 impinges on the panel 37 and urges it into contact with the frusto-conically-shaped upper portion 44a of the anvil 34, which lies directly below and around the installation hole 45. Continued pressing by the shoulder 31 against the panel 37 also reduces the cross-section of the coined portion 36, which process displaces metal from the panel downwardly and inwardly into the undercut 33. The metal from the panel is cold formed into a shape that compliments the shape of the undercut, thereby closing the installation hole 45 around the undercut. The conical shape formed around the fastener during deformation rigidly attaches the fastener 30 to the panel 37.

When used together, the novel fastener 30 and tooling 32, 34 function differently during clinching compared to prior art clinch fasteners and tooling, and create a superior connection between the fastener and panel. For example, the novel fastener 30 and tooling 32, 34 perform at least the following novel steps during clinching: (1) deforming the portion of the panel 37 surrounding the insertion hole 45 into a coined portion 36 having a conical shape; (2) compressing and thinning the coined portion 36 by cold-flow deformation, which results in work-hardening of the coined portion 36; and, (3) closing the installation hole 45 around the neck or undercut 33 of the fastener 30. It should also be appreciated that the clinching method as illustrated in FIG. 4 deforms the metal panel much less than the prior art method illustrated in FIG. 2. If the prior art fastener and method were used to clinch a thin-metal sheet panel, the deformation would almost be great enough to shear through the thin metal.

After clinching, the shank 35 of the fastener has a larger diameter than the installation hole 45, which has been closed around the undercut 33. As a result, the fastener 30 is captivated in the thin panel 37. Referring to FIG. 4, one of skill in the art will appreciate that the geometry of the fastener's retention mechanism in the panel 37 is different than the prior art retention mechanism shown in FIG. 2. The pull-out resistance of the prior art fastener is created mainly by tensile forces, while the pull-out resistance of the novel fastener 30 is created primarily by compressive forces.

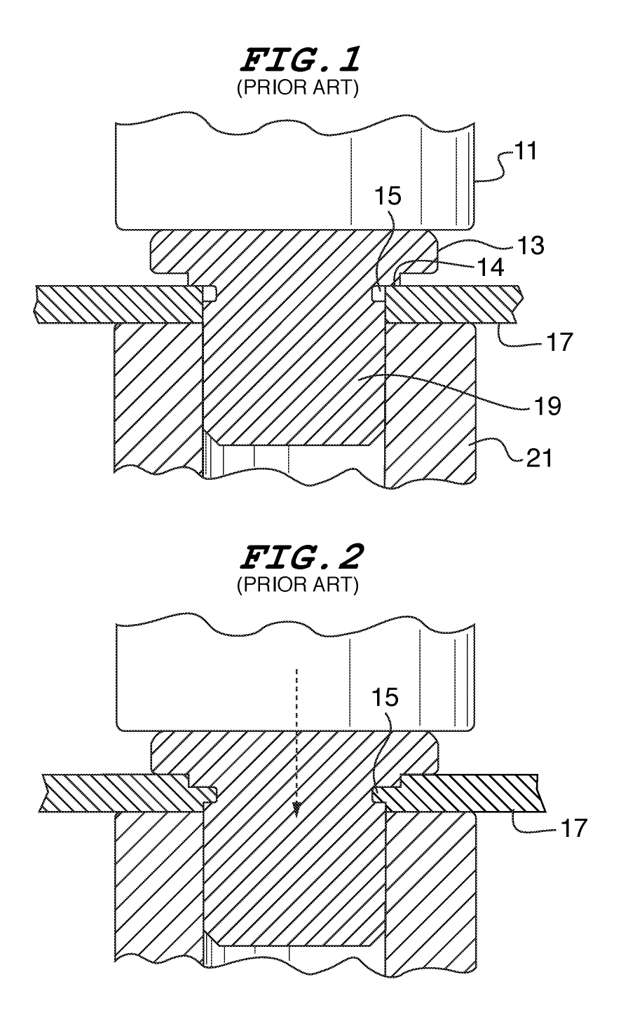

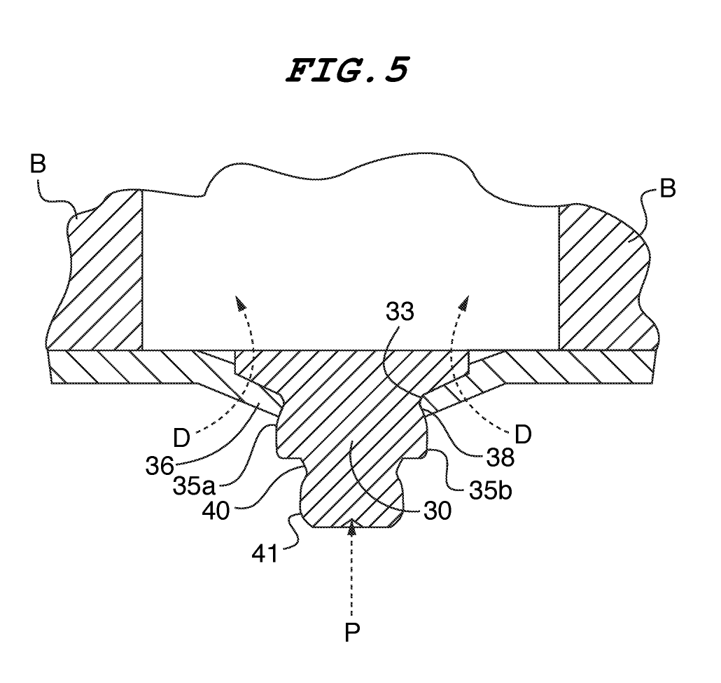

FIG. 5 schematically illustrates the reaction mechanism to a push-out force “P” applied to the fastener of FIG. 4 after the press tool is removed and the panel is supported by push-out bushings “B”. The push-out force acts in the opposition direction of the fastener's installation. Although the push-out force “P” is shown as a force applied to the distal end of the fastener on the backside of the panel, the push-out force may also be a pull-out force on the top side of the panel and exerted on the fastener head. The line of force is indicated by the dashed line adjacent reference letter “P”. The push-out force “P” urges the fastener upward. However, since the distal a portion 35b of the shank 35 has a larger diameter than the installation hole 45 (as constricted during clinching), the shank pushes on the edge 38 of the coined portion 36 and urges it upwardly. In reaction, the coined portion 36 tries to unfold or rotate about its original bending point in the direction shown by the dotted line adjacent reference letter “D.” As this movement occurs, the coined portion tends to move inwardly due to the arc of rotation, and tighten against the neck of the fastener 30 in the undercut 33. The higher the pull-out force P, the harder the hole closes in on the neck of the fastener so that there is no way to loosen this attachment without first yielding metal. In-line compressive forces in the coined section must be overcome prior to the push-out failure of this fastening assembly. Those of skill in the art will readily appreciate how the structural integrity of this assembly differs from a standard clinch attachment as seen in FIGS. 1 and 2.

In the preferred embodiment shown in FIGS. 3-4, the fastener also includes attachment means on the distal portion 35b of the shank 35 for attaching a second panel (not shown). In this preferred embodiment, the attachment means comprises a second undercut 40 and tapered bottom portion 41, which extends distally to the distal end 30b of the fastener 30.

FIGS. 6a-f show fasteners in accordance with additional preferred embodiments of the invention. FIGS. 6(a)-(f) show a pin 130, flush stud 230, heavy head stud 330, standoff 430, nut 530 and flush tack 630, respectively. Each fastener 130, 230, 330, 430, 530, 630 has a circular cross-section and generally comprises a head 142, 242, 342, 442, 542, 642, a displacer 131, 231, 331, 431, 531, 631, an undercut 133, 233, 333, 433, 533, 633, and a shank 130, 230, 330, 430, 530, 630, respectively, arranged sequentially from the head end to the distal free end of the fastener similar to the fastener 30 described above. FIGS. 6(a)-(f) demonstrate how the thin clinching feature of the present invention can be adapted to replace a standard clinch profile in numerous types of fasteners. If a particular application of the fastener requires torque resistance, as in the case of the threaded fastener, the displacer may be knurled.

The above-described embodiments are considered as illustrative only of the principles of the invention. Since numerous modifications and changes will readily occur to those skilled in the art, it is not desired to limit the invention to the exact construction and operation shown and described. Accordingly, all suitable modifications and equivalents may be resorted to, falling within the scope of the invention, which is to be defined by the following claims.

1. A unitary metal fastener comprising:
a top most head, said head having the largest diameter of the fastener;
a shoulder extending axially downward from said head, said shoulder having an outwardly-facing, inwardly-converging angled surface for displacing material of a metal panel into which said fastener is installed;
an outwardly-flared shank located below the shoulder, said shank having an upwardly-facing outer surface adapted to engage an edge of a installation hole in the panel material deformed by said shoulder; and,
a neck of reduced diameter located at a junction of said shank and said shoulder, said neck adapted to accept the installation hole edge of the panel such that the fastener is attached to the panel thereby.

2. The fastener of claim 1 further having attachment means located below the shank for attaching the fastener to a second object through an installation hole in the second object.

3. The fastener of claim 2 wherein said attachment means has an undercut for clinch attachment to the second object.

4. The fastener wherein said head is circular having a cylindrical outer surface.

5. The fastener of claim 1 wherein the outer surface of the shoulder consists entirely of the outwardly facing angled surface.

6. The fastener of claim 2 wherein the attachment means includes a convergently-tapered bottom portion extending downward to a bottom of the fastener.

7. An assembly of a fastener to a sheet metal panel, comprising:
a unitary metal fastener, comprising:
a top most head, said head being the largest diameter of the fastener;
a shoulder extending axially downward from said head, said shoulder having an outwardly facing downwardly convergent angled surface for displacing material of a metal panel into which said fastener is installed;
an outwardly flared shank located immediately below the shoulder, said shank having an upwardly facing outer surface adapted to engage an edge of an installation hole in the panel material deformed by said shoulder; and
a neck of reduced diameter located at the junction of said shank and said shoulder, an area around the neck constituting an undercut adapted to accept the installation hole edge of the panel;
said fastener extending through the installation hole in the panel centered in a conical recessed section of the panel wherein the fastener is rigidly attached to the panel by the cold flow of metal from the panel into the neck undercut thereby reducing the diameter of the installation hole.

8. The assembly of claim 7 wherein the thickness of said panel is approximately 0.008 inches.

9. The assembly of claim 7 further including a second object attached to the fastener by means on the fastener located below the shank.

10. The assembly of claim 7 wherein an edge of the conical section of the panel around the installation hole abuts the shoulder, the conical section being angled downwardly with the edge of the hole engaging the upwardly facing surface of the shank.

11. The assembly of claim 7 wherein a top surface of the head lies flush with a top surface of the panel.

12. The assembly of claim 10 wherein the material of the panel is deformed and the fastener attached to the panel thereby only by pressing the fastener into the panel against an anvil.

13. The assembly of claim 12 wherein the anvil has a conical recess which forms the conical portion of the panel during the pressing.

14. The assembly of claim 10 wherein forces applied to the fastener in the direction opposite to the direction of fastener installation are counteracted primarily by the in-line compressive resistance force of the panel.
